(19) United States
(12) Patent Application Publication
(10) Pub. No.: US 2023/0421774 A1
(43) Pub. Date: Dec. 28, 2023

(54) PACKAGING AND UNPACKAGING METHOD AND APPARATUS FOR POINT CLOUD MEDIA FILE, AND STORAGE MEDIUM

(71) Applicant: TENCENT TECHNOLOGY (SHENZHEN) COMPANY LIMITED, Shenzhen (CN)

(72) Inventor: Ying HU, Shenzhen (CN)

(21) Appl. No.: 18/462,502

(22) Filed: Sep. 7, 2023

Related U.S. Application Data
(63) Continuation of application No. PCT/CN2022/109519, filed on Aug. 1, 2022.

(30) Foreign Application Priority Data
Aug. 26, 2021 (CN) 202110990633.1

(51) Int. Cl. H04N 19/154; H04N 19/42; H04N 19/463; H04N 19/136; H04N 19/124

(52) U.S. Cl. CPC H04N 19/154; H04N 19/42; H04N 19/463; H04N 19/136; H04N 19/124

(57) ABSTRACT

This application provides a packaging method and apparatus for a point cloud media file, a device and a storage medium. The method includes acquiring target point cloud; encoding the target point cloud to obtain an alternative group of the target point cloud, the alternative group comprising N interchangeable media tracks, and N being an integer greater than 1; adding quality indication information into at least one media track among the N media tracks to obtain a media file of the target point cloud, the quality indication information indicating quality of the media track; and packing the media file with first information, the first information indicating quality information of at least one media track among the N media tracks.

### RELATED APPLICATIONS

This application is a continuation of PCT Application No. PCT/CN2022/109519, filed on Aug. 1, 2022, which claims priority to Chinese Patent Application No. 202110990633.1, entitled “PACKAGING AND UNPACKAGING METHOD AND APPARATUS FOR POINT CLOUD MEDIA FILE AND STORAGE MEDIUM”, filed with the China Patent Office on Aug. 26, 2021. The two applications are incorporated by reference in their entirety.

### FIELD OF THE TECHNOLOGY

Embodiments of this application relate to the technical field of video processing, in particular to a packaging and unpackaging method and apparatus for a point cloud media file, and a storage medium.

### BACKGROUND OF THE DISCLOSURE

Point cloud is a set of randomly distributed discrete points in a space that expresses a spatial structure and surface attribute of a three-dimensional object or scenario. Point cloud media may be divided into 3 degrees of freedom (DoF) media, 3DoF+media and 6DoF media according to the degree of freedom of users when consuming media contents.

In a process of packaging the point cloud media, there is an alternative group, that is, a plurality of tracks with the same contents may be alternated with one another during presentation due to differentiation (such as a coding mode and a code rate). These interchangeable tracks may form an alternative group. During consumption of a file unpackaging device, one track in the alternative group is consumed each time.

However, in the current point cloud media packaging technology, for the plurality of tracks in the alternative group, the file unpackaging device cannot determine which track is specifically consumed, resulting in low decoding efficiency of the point cloud media.

### SUMMARY

This application provides a packaging method and apparatus for a point cloud media file, a device and a storage medium. A certain track may be selectively consumed according to quality information of a media track in an alternative group, so that wide band and decoding resources are saved, and the decoding efficiency is improved.

One aspect of this application provides a packaging method for a point cloud media file applied to a file packaging device. The method includes acquiring target point cloud; encoding the target point cloud to obtain an alternative group of the target point cloud, the alternative group comprising N interchangeable media tracks, and N being an integer greater than 1; adding quality indication information into at least one media track among the N media tracks to obtain a media file of the target point cloud, the quality indication information indicating quality of the media track; and packing the media file with first information, the first information indicating quality information of at least one media track among the N media tracks.

A second aspect of this application provides an unpackaging method for a point cloud media file, applied to a file unpackaging device. The method includes receiving first information transmitted by a file packaging device, the first information indicating quality information of at least one media track among N media tracks of target point cloud, the N media tracks being N interchangeable media tracks in an alternative group of the target point cloud, at least one media track among the N media tracks comprising quality indication information, the quality indication information indicating quality of the media track, and N being an integer greater than 1.

Another aspect of this application provides a file packaging device, including a processor and a memory, the memory being configured to store a computer program, and the processor being configured to invoke and run the computer program stored in the memory, to execute the method in the first aspect.

Another aspect of this application provides a file unpackaging device, including: a processor and a memory, the memory being configured to store a computer program, and the processor being configured to invoke and run the computer program stored in the memory, to execute the method in the second aspect.

In embodiments consistent with the present disclosure, the file packaging device acquires and codes the target point cloud to obtain the alternative group of the target point cloud, the alternative group includes N interchangeable media tracks, the quality indication information is added into at least one media track among the N media tracks to obtain the media file of the target point cloud, and the quality indication information is used for indicating the quality of the media track; and then, the file packaging device sends the first information to the file unpackaging device, and the first information is used for indicating the quality information of the at least one media track among the N media tracks. Accordingly, the file unpackaging device may determine the media track that needs to be requested or decoded according to the quality information of at least one media track indicated by the first information. This conserves network resources, and improves the decoding efficiency.

### BRIEF DESCRIPTION OF THE DRAWINGS

In order to describe technical solutions in embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other accompanying drawings according to these accompanying drawings without creative efforts.

FIG. 1 illustrates a schematic diagram of three degrees of freedom.

FIG. 2 illustrates a schematic diagram of three degrees of freedom+.

FIG. 3 illustrates a schematic diagram of six degrees of freedom.

FIG. 4A is an architecture diagram of an immersive media system provided by an embodiment of this application.

FIG. 4B is a schematic content flowchart of V3C media provided by an embodiment of this application.

FIG. 4C is a schematic diagram of an alternative group involved in an embodiment of this application.

FIG. 5 is an interactive flowchart of a packaging and unpackaging method for a

point cloud media file provided by an embodiment of this application.

FIG. 6A is a schematic diagram of an alternative group involved in an embodiment of this application.

FIG. 6B is a schematic diagram of another alternative group involved in an embodiment of this application.

FIG. 7 is an interactive flowchart of a packaging and unpackaging method for a point cloud media file provided by an embodiment of this application.

FIG. 8 is an interactive flowchart of a packaging and unpackaging method for a point cloud media file provided by an embodiment of this application.

FIG. 9 is a schematic structural diagram of a packaging apparatus for a point cloud media file provided by an embodiment of this application.

FIG. 10 is a schematic structural diagram of an unpackaging apparatus for a point cloud media file provided by an embodiment of this application.

FIG. 11 is a schematic block diagram of an electronic device provided by an embodiment of this application.

### DESCRIPTION OF EMBODIMENTS

The following will clearly and completely describe the technical solutions in the embodiments of the present disclosure with reference to the accompanying drawings in the embodiments of the present disclosure. Apparently, the described embodiments are merely some of the embodiments of the present disclosure rather than all of the embodiments. All other embodiments obtained by persons of ordinary skill in the art based on the embodiments of the present disclosure without creative efforts shall fall within the protection scope of the present disclosure.

In the specification, claims, and the foregoing accompanying drawings of the present disclosure, the terms “first”, “second”, and so on are intended to distinguish between similar objects rather than indicating a specific order. It is to be understood that data used in this way is exchangeable in a proper case, so that the embodiments of the present disclosure described herein can be implemented in an order different from the order shown or described herein. Moreover, the terms “include”, “contain” and any other variants mean to cover the non-exclusive inclusion, for example, a process, method, system, product, or server that includes a list of steps or units is not necessarily limited to those expressly listed steps or units, but may include other steps or units not expressly listed or inherent to such a process, method, system, product, or device.

The embodiments of this application relate to a data processing technology of point cloud media.

The solutions provided by this application may further relate to a coding and decoding standard or technology.

The solutions provided by the embodiments of this application may be applied to the technical field of digital video coding, such as image coding and decoding, video coding and decoding, hardware video coding and decoding, dedicated circuit video coding and decoding, and real-time video coding and decoding. Alternatively, the solutions provided by the embodiments of this application may be combined with an audio video coding standard (AVS), a second-generation AVS standard (AVS2) or a third-generation AVS standard (AVS3). It specifically includes, but is not limited to an H.264/audio video coding (AVC) standard, an H.265/high efficiency video coding (HEVC) standard and an H.266/versatile video coding (VVC) standard. Alternatively, the solutions provided by the embodiments of this application may be combined with other proprietary or industry standards, for example, it may specifically contain ITU-TH.261, ISO/IECMPEG-1Visual, ITU-TH.262 or ISO/IECMPEG-2Visual, ITU-TH.263, ISO/IECMPEG-4Visual, and ITU-TH.264 (may also be called ISO/IECMPEG-4AVC), and also contain scalable video codec (SVC) and multi-view video codec (MVC) extensions.

In addition, the solutions provided by the embodiments of this application may be used for performing lossy compression on an image, and may also be used for performing lossless compression on the image. The lossless compression may be visually lossless compression, and may also be mathematically lossless compression.

The solutions provided by this application may further relate to the field of vehicular technologies.

For example, a client involved in this application may be a user terminal. In some embodiments, the user terminal includes, but is not limited to a mobile phone, a computer, an intelligent speech interaction device, intelligent household electrical appliance, a vehicle-mounted terminal, an aircraft and the like.

Before the technical solutions in this application are introduced, related knowledge of this application is introduced first below:

Point cloud: the point cloud is a set of randomly distributed discrete points in a space that expresses a spatial structure and surface attribute of a three-dimensional object or scenario. Each point in the point cloud at least has three-dimensional position information, and may further have color, material and other information according to different application scenarios. Usually, each point in the point cloud has the same quantity of additional attributes.

Visual volumetric video-based coding (V3C) media: it refers to an immersive media that captures visual contents from a three-dimensional space, provides a 3DoF+ and 6DoF viewing experience, is coded with a traditional video and contains volumetric video type tracks in file packaging, including multi-view videos, video coding point cloud and the like.

PCC: point cloud compression.

G-PCC: geometry-based point cloud compression.

V-PCC: video-based point cloud compression.

Atlas: it indicates region information on a 2D plane frame, region information in a 3D presentation space, as well as a mapping relationship between the two and necessary parameter information required for mapping.

Track: a media data set in a packaging process of a media file, a media file may be composed of a plurality of tracks, for example, a media file may contain a video track, an audio track and a subtitle track.

Sample: a packaging unit in the packaging process of the media file, and a media track is composed of a plurality of samples. For example, a sample of the video track is usually a video frame.

DoF: degree of freedom. In a mechanical system, it refers to the quantity of independent coordinates, which includes not only the degree of freedom for translation, but also the degree of freedom for rotation and vibration. In the embodiments of this application, it refers to the degree of freedom of a motion that a user supports and generates content interaction when watching the immersive media.

3DoF: three degrees of freedom, referring to the three degrees of freedom that a user's head rotates around X, Y and Z axes. FIG. 1 schematically illustrates a schematic diagram of three degrees of freedom. As shown in FIG. 1, rotation is available on all three axes at a certain location or point, and turning the head, lowering the head up and down, or swinging the head are also available. Through the three-degree of freedom experience, the user can immerse himself 360 degrees in a live environment. If it is static, it may be understood as a panoramic picture. If the panoramic picture is dynamic, it is a panoramic video, namely a VR video. However, the VR video has certain limitations, the user cannot move and choose any place to watch.

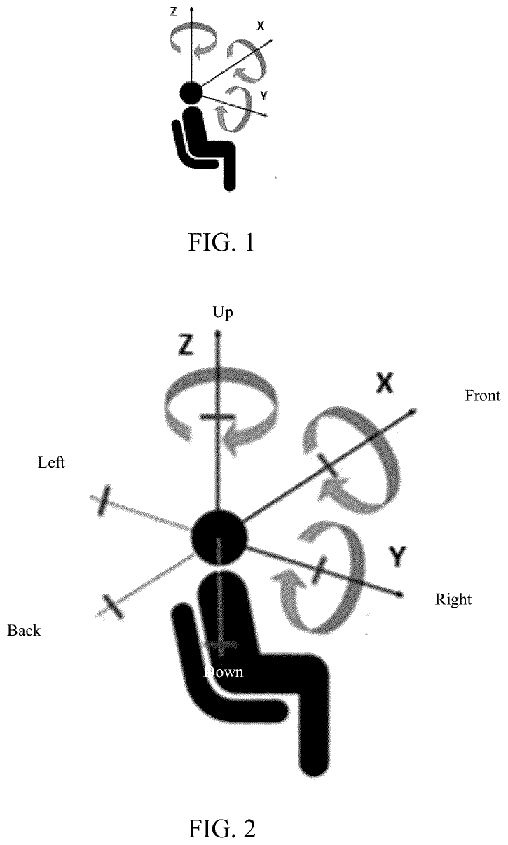

3DoF+: on the basis of three degrees of freedom, the user further has the degree of freedom to make limited movement along the X, Y and Z axes, which may also be called restricted six degrees of freedom, and the corresponding media code stream may be called restricted six degrees of freedom media code stream. FIG. 2 schematically illustrates a schematic diagram of three degrees of freedom+.

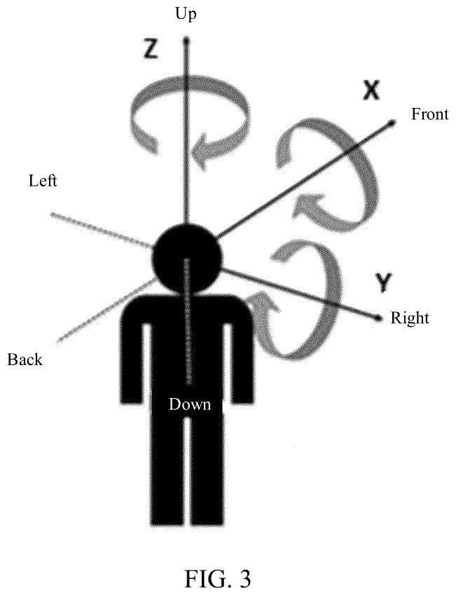

6DoF: on the basis of three degrees of freedom, the user further has the degree of freedom to make free movement along the X, Y and Z axes, and the corresponding media code stream may be called six degrees of freedom media code stream. FIG. 3 schematically illustrates a schematic diagram of six degrees of freedom. 6DoF media refers to a 6-degree of freedom video, which may provide the user with a freely moving viewpoint in directions of the X, Y and Z axes in a three-dimensional space and a high-degree of freedom viewing experience of a freely rotating viewpoint surrounding the X, Y and Z axes. The 6DoF media is a combination of videos from different spatial perspectives captured by a camera array. In order to facilitate the expression, storage, compression and processing of the 6DoF media, 6DoF media data is expressed as a combination of the following information: a texture map captured by multiple cameras, a depth map corresponding to the multi-camera texture map and corresponding 6DoF media content description metadata, the metadata contains parameters of the multiple cameras, and splicing layout, edge protection and other description information of the 6DoF media. At a coding end, splicing processing is performed on the texture map information and the corresponding depth map information of the multiple cameras, and description data of a splicing mode is written into the metadata according to defined syntax and semantics. The spliced depth map and texture map information of the multiple cameras is coded through a flat video compression mode, and transmitted to a terminal for decoding, then synthesis of 6DoF virtual viewpoints requested by the user is performed, and thus viewing experience of the 6DoF media is provided to the user.

AVS: audio video coding standard.

ISOBMFF: international standard organization (ISO) based media file format. ISOBMFF is a packaging standard of a media file, the most typical ISOBMFF file is a moving picture experts group 4 (MP4) file.

DASH: dynamic adaptive streaming over HTTP, DASH is an adaptive bit rate streaming technology, which enables a high-quality streaming media to be transferred over the Internet through a traditional HTTP network server.

MPD: media presentation description, which is media presentation description signaling in the DASH for describing media segment information.

HEVC: high efficiency video coding, which is an international video coding standard HEVC/H.265.

VVC: versatile video coding, which is an international video coding standard VVC/H.266.

Intra (picture) Prediction: intra-frame prediction.

Inter (picture) Prediction: inter-frame prediction.

SCC: screen content coding.

QP: quantization parameter.

The immersive media refers to a media content that can provide consumers with an immersive experience, and the immersive media may be divided into 3DoF media, 3DoF+ media and 6DoF media according to the degree of freedom of users when consuming media contents. The common 6DoF media includes point cloud media.

The point cloud is a set of randomly distributed discrete points in a space that expresses a spatial structure and surface attribute of a three-dimensional object or scenario. Each point in the point cloud at least has three-dimensional position information, and may further have color, material and other information according to different application scenarios. Usually, each point in the point cloud has the same quantity of additional attributes.

The point cloud may flexibly and conveniently express a spatial structure and surface attributes of a three-dimensional object or scenario, so that application is wide. It includes a virtual reality (VR) game, computer aided design (CAD), a geography information system (GIS), an autonomous navigation system (ANS), digital cultural heritage, free viewpoint broadcasting, three-dimensional immersive telepresence, three-dimensional reconstruction of biological tissues and organs, and the like.

The main ways to acquire the point cloud are as follows: computer generation, 3D laser scanning, 3D photogrammetry and the like. A computer may generate point cloud of a virtual three-dimensional object and scenario. 3D scanning may obtain point cloud of a three-dimensional object or scenario in the static real world, and may acquire point cloud of millions per second. 3D camera shooting may obtain point cloud of a three-dimensional object or scenario in the dynamic real world, and may acquire point cloud of tens of millions per second. In addition, in the medical field, information is positioned by MRI, CT and electromagnetism, and point cloud of biological tissues and organs may be obtained. These technologies reduce costs and shorten a time cycle of point cloud data acquisition, and an accuracy of the data is improved. The transformation of point cloud data acquisition methods has made it possible to acquire a large quantity of point cloud data. With the continuous accumulation of large-scale point cloud data, efficient storage, transmission, publication, sharing and standardization of the point cloud data have become the key to point cloud applications.

After coding the point cloud media, it is necessary to package a coded data stream and transmit it to the user. Correspondingly, at a point cloud media player side, it is necessary to unpackage a point cloud file, then decode it, and finally present a decoded data stream. Therefore, in the unpackaging process, after acquiring specific information, the efficiency of the decoding process can be improved to a certain extent, so that a better experience is brought for the presentation of the point cloud media.

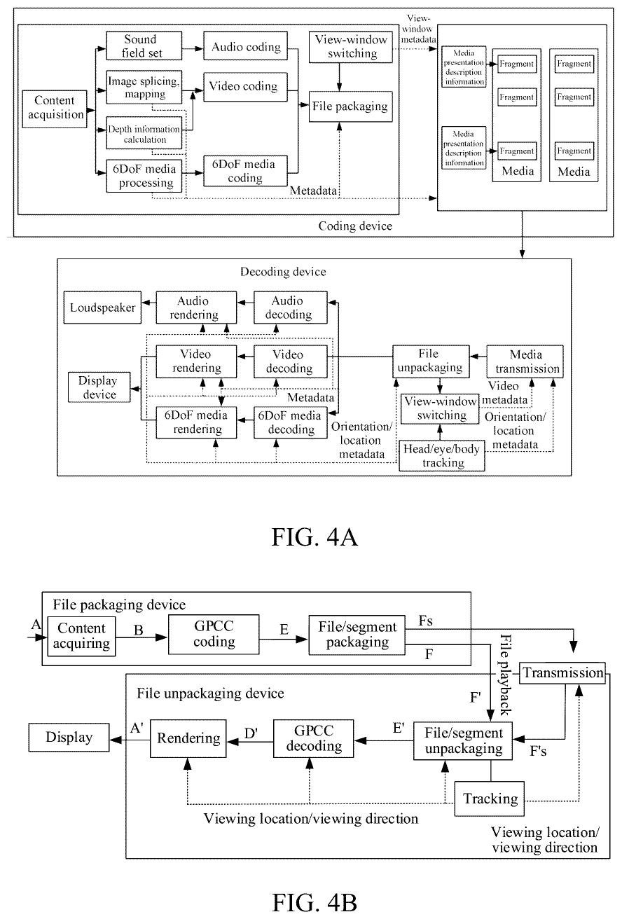

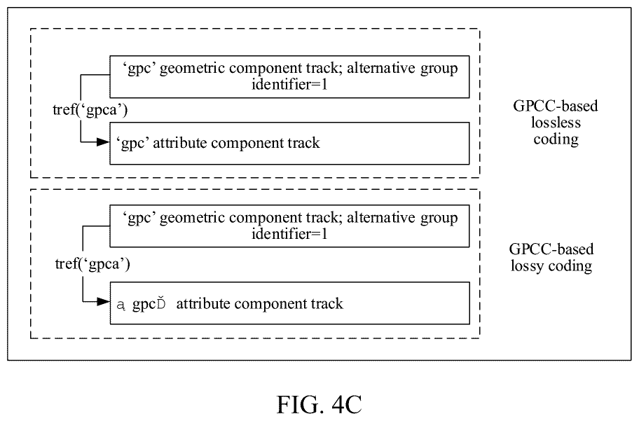

FIG. 4A is an architecture diagram of an immersive media system provided by an embodiment of this application. As shown in FIG. 4A, the immersive media system includes a coding device and a decoding device, the coding device may refer to a computer device used by a provider of an immersive media, and the computer device may be a terminal (such as a personal computer (PC)), a smart mobile device (such as a smart phone) or a server. The decoding device may refer to a computer device used by a user of the immersive media, and the computer device may be a terminal (such as a personal computer (PC)), a smart mobile device (such as a smart phone), and a VR device (such as a VR helmet and VR glasses). The data processing process of the immersive media includes a data processing process at a coding device side and a data processing process at a decoding device side.

The data processing process at the coding device side mainly includes:

(1) acquiring and making processes of a media content of the immersive media; and

(2) a process for coding the immersive media and packaging a file. The data processing process at the decoding device side mainly includes:

(3) a process for unpackaging and decoding the file of the immersive media; and

(4) a rendering process of the immersive media.

In addition, the coding device and the decoding device involve a transmission process of the immersive media therebetween, the transmission process may be performed based on various transmission protocols, and the transmission protocols here may include, but are not limited to: a dynamic adaptive streaming over HTTP (DASH) protocol, an HTTP live streaming (HLS) protocol, a smart media transport protocol (SMTP), a transmission control protocol (TCP) and the like.

The following will provide a detailed introduction to the various processes involved in the data processing process of the immersive media with reference to FIG. 4A.

1. The data processing process at the coding device side:

(1) the acquiring and making processes of the media content of the immersive media.

1) The acquiring process of the media content of the immersive media.

The media content of the immersive media is obtained by collecting a real-world sound-vision scenario through a capture device.

In an implementation, the capture device may refer to a hardware component arranged in the coding device, for example, the capture device refers to a microphone, a camera, a sensor and the like of the terminal. In another implementation, the capture device may also be a hardware apparatus connected with the coding device, such as a camera connected with the server.

The capture device may include, but is not limited to an audio device, a camera shooting device and a sensing device. The audio device may include an audio sensor, a microphone and the like. The camera shooting device may include a regular camera, a stereo camera, a light field camera and the like. The sensing device may include a laser device, a radar device and the like.

There may be a plurality of capture devices, these capture devices are deployed at some specific positions in a real space, to simultaneously capture audio contents and video contents from different angles in the space, and the captured audio contents and video contents remain synchronized in both time and space. The media content collected by the capture device is called original data of the immersive media.

2) The making process of the media content of the immersive media.

The captured audio contents themselves are the contents suitable for being subjected to audio coding of the immersive media. The capture video content may become the content suitable for being subjected to video coding of the immersive media only after a series of making flows, and the making flows include:

\textcircled{1} Splicing. Since the captured video contents are obtained by the capture device shooting at different angles, splicing refers to splicing these video contents shot from various angles into a complete video that can reflect a 360-degree visual panoramic view of a real space, that is, the spliced video is a panoramic video (or spherical video) represented in a three-dimensional space.

\textcircled{2} Projection. Projection refers to a process of mapping a three-dimensional video formed by splicing onto a 2-dimensional (2D) image, and the 2D image formed by projection is called a projection image; and a projection mode may include, but is not limited to: longitude and latitude map projection and regular hexahedron projection.

\textcircled{3} Region packaging. The projection image may be directly coded, and the projection image may also be coded after region packaging. In practice, it has been found that in the data processing process of the immersive media, a situation that the 2D projection image is coded after region packaging can greatly improve the video coding efficiency of the immersive media, and therefore, the region packaging technology is widely applied to a video processing process of the immersive media. The so-called region packaging refers to a process of converting the projection image according to regions, and the region packaging process converts the projection image into a packaging image. The region packaging process specifically includes dividing the projection image into a plurality of mapping regions, then conversion processing is performed on the plurality of mapping regions respectively to obtain a plurality of packaging regions, and the plurality of packaging regions are mapped into a 2D image to obtain the packaging image. The mapping regions refer to regions obtained by dividing in the projection image before performing region packaging; and the packaging regions refer to regions located in the packaging image after performing region packaging.

The conversion processing may include, but is not limited to mirroring, rotating, re-arranging, upsampling, downsampling, changing a resolution ratio of the region, moving and other processing.

Since adopting the capture device can only capture the panoramic video, such video is processed by the coding device and transmitted to the decoding device for corresponding data processing, and then a user at the decoding device side can view 360-degree video information only by performing specific actions (such as head rotation), while performing non-specific actions (such a moving the head) cannot obtain corresponding video changes, resulting in poor VR experience. Therefore, it is necessary to provide additional depth information matched with the panoramic video to enable the user to obtain better immersion and better VR experience, which involves six degrees of freedom (6DoF) making technology. When the user may freely move in a simulated scenario, it is called 6DoF. When the 6DoF making technology is adopted to make the video contents of the immersive media, the capture device may generally use the light field camera, the laser device, the radar device and the like to capture point cloud data or light field data in the space. In addition, during the execution of the above making flows \textcircled{1} to \textcircled{2}, some specific processing further needs to be performed, such as the curling and mapping processes of the point cloud data, and a calculation process of depth information.

(2) The process for coding the immersive media and packaging the file.

The captured audio content may be directly subjected to audio coding to form an audio code stream of the immersive media. After the above making flows to \textcircled{1} to \textcircled{2} or \textcircled{1} to \textcircled{3}, video coding is performed on the projection image or the packaging image to obtain a video code stream of the immersive media. For example, a packing picture (D) is coded as a coding image (Ei) or a coding video bit stream (Ev). Captured audio (Ba) is coded as an audio bit stream (Ea). Then, according to a specific media container file format, the coded image, video and/or audio are combined into a media file (F) for file playback or a sequence of initialization and media segments (Fs) for streaming transmission. The coding device side further includes metadata, such as projection and region information, into files or segments to help present decoded packed pictures.

If the 6DoF making technology is adopted, it is necessary to adopt a specific coding mode (such as point cloud coding) for coding in the video coding process. The audio code stream and the video code stream are packaged into a file container according to a file format (such as an ISO based media file format) to form a media file resource of the immersive media, and the media file resource may be a media file or media segment to form the media file of the immersive media; and media presentation description (MPD) information is adopted to record metadata of the media file resource of the immersive media according to file format requirements of the immersive media, here the metadata is a general term for information related to presentation of the immersive media, and the metadata may include description information of the media content, description information of a view-window, signaling information related to presentation of the media content and the like. As shown in FIG. 4A, the coding device may store the media presentation description information and the media file resource which are formed after the data processing process.

The immersive media system supports a box, the box refers to a data block or object including the metadata, that is, the box contains the metadata of the corresponding media content. The immersive media may include a plurality of boxes, such as a sphere region zooming box, which contains metadata used for describing sphere region zooming information; a 2D region zooming box, which contains metadata used for describing 2D region zooming information; and a region wise packing box, which contains metadata used for describing corresponding information in the region packaging process.

2. The data processing process at the decoding device side:

(3) the process for unpackaging and decoding the file of the immersive media.

The decoding device may adaptively and dynamically obtain the media file resource and the corresponding media presentation description information of the immersive media from the coding device through recommendation of the coding device or according to user demands of the decoding device side. For example, the decoding device may determine an orientation and a location of the user according to the head/eyes/body of the user, and then dynamically request to obtain the corresponding media file resource from the coding device based on the determined orientation and location. The media file resource and the media presentation description information are transmitted to the decoding device by the coding device through a transmission mechanism (such as the DASH and the SMT). The file unpackaging process of the decoding device side is opposite to the file packaging process of the coding device side, and the decoding device unpackage the media file resource according to the file format requirements of the immersive media to obtain the audio code stream and the video code stream. The decoding process of the decoding device side is opposite to the coding process of the coding device, and the decoding device performs audio decoding on the audio code stream to restore the audio contents.

In addition, the decoding process of the video code stream by the decoding device includes the following:

\textcircled{1} decoding the video code stream to obtain a flat image, according to the metadata provided by the media presentation description information, if the metadata indicates that the immersive media has executed the region packaging process, the flat image referring to the packaging image, and if the metadata indicates that the immersive media has not executed the region packaging process, the flat image referring to the projection image;

\textcircled{2} if the metadata indicates that the immersive media has not executed the region packaging process, performing, by the decoding device, region unpackaging on the packaging image to obtain the projection image. Here, the region unpackaging is opposite to the region packaging, the region unpackaging refers to a process of inverse converting the packaging image according to the regions, and the region unpackaging converts the packaging image into the projection image. The region unpackaging process specifically includes: performing inverse conversion processing on a plurality of packaging regions in the packaging image according to indication of the metadata to obtain a plurality of mapping regions, and mapping the plurality of mapping regions to a 2D image to obtain the projection image. The inverse conversion processing refers to processing opposite to conversion processing, for example: the conversion processing refers to rotating 90 degrees counterclockwise, and then inverse conversion processing refers to rotating 90 degrees clockwise.

\textcircled{3} Performing reconstruction processing on the projection image according to the media presentation description information to be converted into a 3D image, and the reconstruction processing here refers to processing of re-projecting the two-dimensional projection image into a 3D space.

(4) The rendering process of immersive media.

The decoding device renders the audio contents obtained by audio decoding and the 3D image obtained by video decoding according to the metadata related to rendering and view-window in the media presentation description information, and playing and outputting of the 3D image are realized after rendering is completed. Specifically, if the 3DoF and 3DoF+ making technologies are adopted, the decoding device renders the 3D image mainly based on a current viewpoint, a view difference, depth information and the like, and if the 6DoF making technology is adopted, the decoding device renders the 3D image in the view-window based on mainly based on the current viewpoint. The viewpoint refers to a view location point of the user, the view difference refers to a sight line difference generated by both eyes of the user, or a sight line difference generated by motion, and the view-window refers to a viewing region.

The immersive media system supports a box, the box refers to a data block or object including the metadata, that is, the box contains the metadata of the corresponding media content. The immersive media may include a plurality of boxes, such as a sphere region zooming box, which contains metadata used for describing sphere region zooming information; a 2D region zooming box, which contains metadata used for describing 2D region zooming information; and a region wise packing box, which contains metadata used for describing corresponding information in the region packaging process.

FIG. 4B is a schematic content flowchart of GPCC point cloud media provided by an embodiment of this application. As shown in FIG. 4B, the immersive media system includes a file packaging apparatus and a file unpackaging apparatus. In some embodiments, the file packaging apparatus may be understood as the above coding device, and the file unpackaging apparatus may be understood as the above decoding device.

A visual scenario (A) in the real world is captured by a group of cameras or a camera device with a plurality of lenses and sensors. The collection result is source point cloud data (B). One or more point cloud frames are coded into a G-PCC bit stream, including a coded geometric bit stream and a coded attribute bit stream (E). Then, according to a specific media container file format, one or more coded bit streams are combined into a media file (F) for file playback or a sequence of initialization and media segments for streaming transmission (Fs). In this application, the media container file format is the ISO based media file format specified in ISO/IEC 14496-12. The file packaging apparatus further contains the metadata into the file or segments. The segments Fs are transferred to a player by using a transferring mechanism.

The file (F) output by the file packaging apparatus is the same as the file (F′) inputted by the file unpackaging apparatus. The file unpackaging apparatus processes the file (F′) or a received segment (F′s), extracts a coded bit stream (E′) and parses the metadata. Then the G-PCC bit stream is decoded as a decoding signal (D′), and the point cloud data is generated from the decoding signal (D′). Where applicable, according to the current viewing location, viewing direction or viewports determined by various types of sensors (such as the head), the point cloud data is rendered and dynamically displayed on a head-mounted display or a screen of any other display device, and dynamic displaying may be implemented by using a location sensor or an eye movement sensor. In addition to being used by the player to access appropriate parts of the decoded point cloud data, the current viewing location or viewing direction may also be used for decoding optimization. In transfer related to the viewports, the current viewing location and viewing direction are also transferred to a policy module, which determines a track for receiving.

The above process is suitable for real-time and on-demand use cases. Parameters in FIG. 4B are defined as follows:

E/E′: a coded G-PCC bit stream;

F/F′: a media file including track format specifications, which may contain constraints on basic streams contained in track samples.

Alternative group technology

A plurality of tracks with the same content may be alternated with one another during presentation due to differentiation (such as a coding mode and a code rate), these interchangeable tracks may form an alternative group, and the tracks in one alternative group may be identified by an alternative group ID. During consumption of a file unpackaging device (such as a client), one track in the alternative group is consumed each time. As shown in FIG. 4C, a media track 1 and a media track 2 both include identifiers of the alternative group, that is, alternative group=1, and in this way, it may be determined that the media track 1 and the media track 2 belong to one alternative group, and are the media tracks that may be alternated with each other is the alternative group. The media track 1 includes a geometric component sub-track and an attribute component sub-track, the media track 2 includes a geometric component sub-track and an attribute component sub-track, and coding of an attribute component depends on a geometric component. Coding modes of the media track 1 and the media track 2 are different, for example, the media track 1 is obtained by coding through a GPCC-based lossless coding mode, and the media track 2 is obtained by coding through a GPCC-based lossy coding mode.

In DASH signaling, preselection is defined to organize the alternative group, and @gpcld is taken to identify one alternative group.

A plurality of versions of the same point cloud media shall use separate preselection to send signals. The preselections representing alternative versions of the same geometry-based point cloud media shall contain a GPCC descriptor with the same @gpcld value. There shall be at most one GPCC descriptor in a preselection level. These preselections are substitutes for each other. The id of a main GPCC adaptation set is the first id in an id list of a preselection adaption set, followed by an id of a component adaption set.

From the above, it may be seen that in a current technology, the alternative group may associate point cloud media tracks with different qualities together, so that the user selectively acquires or decodes media resources with a specific quality according to factors such as a network bandwidth and device capacity when requesting the media resources or decoding the media resources. However, for the media resources in the alternative group, there is no clear identifier to distinguish the qualities of these media resources, that is, there is no explicit definition of the quality level of different media resources, causing the file unpackaging device to be unable to determine which media resource is specifically consumed, resulting in low decoding efficiency of the point cloud media.

In order to solve the above technical problems, in this application, the quality indication information is added to at least one media track in the alternative group, the quality indication information is used for indicating the quality of the media track, in this way, the file unpackaging device may selectively consume the specific media track in the alternative group according to the quality indication information of the media track and combined with its own network and other conditions, so that the wide band and decoding resources are saved, and the decoding efficiency is improved.

The technical solution of the embodiments of this application is described in detail below through some embodiments. The following embodiments may be mutually combined, and same or similar concepts or processes may not be repeatedly described in some embodiments.

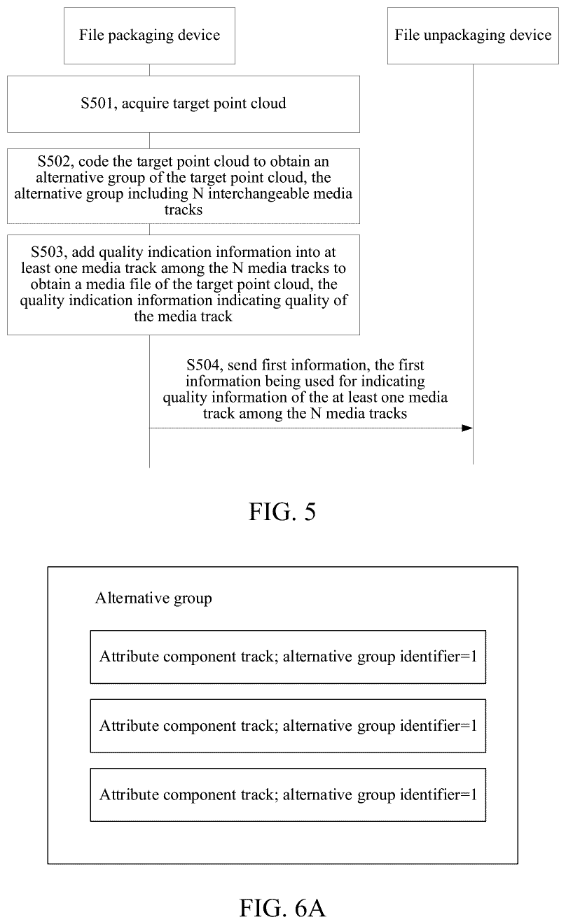

FIG. 5 is an interaction flowchart of a packaging and unpackaging method for a point cloud media file provided by an embodiment of this application. As shown in FIG. 5, the method includes the following steps:

S501: Acquire, by a file packaging device, target point cloud.

In some embodiments, the file packaging device may also be called a video packaging device, or a video coding device.

In an example, the above target point cloud is global point cloud.

In another example, the above target point cloud is a part of global point cloud, such as a subset of the global point cloud.

In some embodiments, the target point cloud is also called target point cloud data, a target point cloud media content, a target point cloud content or the like.

In this embodiment, the methods for acquiring the target point cloud by the file packaging device include but are not limited to the following:

method 1: acquiring, by the file packaging device, the target point cloud from a point cloud collection device, for example, acquiring, by the file packaging device, point cloud collected by the point cloud collection device from the point cloud collection device as the target point cloud.

Method 2: acquiring, by the file packaging device, the target point cloud from a storage device, for example, after the point cloud collection device collects point cloud data, storing the point cloud data in the storage device, and acquiring, by the file packaging device, the target point cloud from the storage device.

Method 3: when the above target point cloud is partial point cloud, after the file packaging device acquires the global point cloud according to the above method 1 or method 2, dividing the global point cloud into blocks, and taking one block as the target point cloud.

S502: Code, by the file packaging device, the target point cloud to obtain an alternative group of the target point cloud, the alternative group including N interchangeable media tracks.

N is an integer greater than 1, and the alternative group includes at least two interchangeable media tracks.

In an example, the alternative group of the above target point cloud may be an alternative group of an attribute component of the target point cloud, and then the N media tracks are N attribute component tracks of the target point cloud.

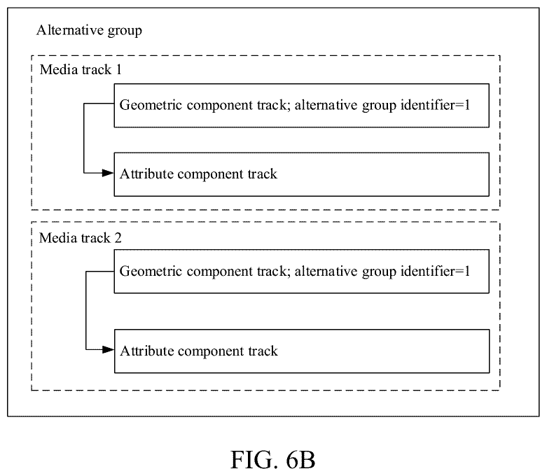

As shown in FIG. 6A, a geometric component (namely geometric information) of the target point cloud is coded to form a geometric component track. 3 different coding methods are adopted to code an attribute component (namely attribute information) of the target point cloud to obtain 3 attribute component tracks, and these 3 attribute component tracks may be alternated with one another to form an alternative group, which is N=3. These 3 attribute component tracks are all identified by alternative group IDs, and these 3 attribute component tracks are related to the geometric component track of the target point cloud. During decoding, the geometric component track may be decoded first, and then one of these 3 attribute component tracks is selected to be decoded to obtain a reconstruction value of the attribute component of the target point cloud.

In an example, the alternative group of the above target point cloud may be an alternative group of a geometric component and an attribute component of the target point cloud, and then each media track among the N media tracks includes a geometric component sub-track and an attribute component sub-track.

For example, as shown in FIG. 6B, two coding methods are adopted to code the geometric component of the target point cloud to obtain 2 geometric component tracks, denoted as a geometric component track 1 and a geometric component track 2 respectively. Since coding of the attribute component of the target point cloud depends on coding of the geometric component, when the geometric component has 2 geometric component tracks, the attribute component of the target point cloud is coded to form 2 attribute component tracks, denoted as an attribute component track 1 and an attribute component track 2 respectively. The 2 attribute component tracks are in one-to-one correspondence with the 2 geometric component tracks, for example, the geometric component track 1 corresponds to the attribute component track 1, the geometric component track 2 corresponds to the attribute component track 2, and the media track 1 composed of the geometric component track 1 and the attribute component track 1 may be alternated with the media track 2 composed of the geometric component track 2 and the attribute component track 2. Therefore, for the convenience of description, here, the geometric component track 1 and the attribute component track 1 are denoted as a geometric component sub-track 1 and an attribute component sub-track 1, and the geometric component sub-track 1 and the attribute component sub-track 1 form a track group to be denoted as a media track. Similarly, the geometric component track 2 and the attribute component track 2 are denoted as a geometric component sub-track and an attribute component sub-track 2, the geometric component sub-track 2 and the attribute component sub-track 2 form a track group to be denoted as a media track, and at this time, N=2.

S503: Add, by the file packaging device, quality indication information into at least one media track among the N media tracks to obtain a media file of the target point cloud, the quality indication information being used for indicating quality of the media track.

In an example, the quality indication information is added into each media track among the N media tracks for indicating the quality of each media track. For example, N=2, the quality indication information is added into the media track 1 for indicating quality of the media track 1, and the quality indication information is added into the media track 2 for indicating quality of the media track 2.

In an example, the quality indication information is added into the media track with the best quality among the N media tracks for indicating quality of the media track. For example, N=2, the quality of the media track 1 is greater than the quality of the media track 2, and then the quality indication information is added into the media track 1 for indicating the quality of the media track 1.

In an example, the quality indication information is added into a media track with the worst quality among the N media tracks for indicating the quality of the media track. For example, N=2, the quality of the media track 1 is greater than the quality of the media track 2, and then the quality indication information is added into the media track 2 for indicating the quality of the media track 2.

In an example, the quality indication information is added into the media tracks with the best quality and the worst quality among the N media tracks. For example, N=3, the quality of the media track 1 is greater than the quality of the media track 2, the quality of the media track 2 is greater than the quality of a media track 3, then the quality indication information is added into the media track 1 for indicating the quality of the media track 1, and the quality indication information is added into the media track 3 for indicating the quality of the media track 3.

A specific adding location of the quality indication information in the media track is not limited in this embodiment, and may be specifically determined according to specific scenarios. In an example, it may be added into a sample head of the media track as a part of metadata of the media track.

In this embodiment, a specific indication form of the quality indication information includes, but is not limited to the following:

method 1: the quality indication information is used for indicating that the quality of the media track is related to a first parameter corresponding to the media track.

In some embodiments, the first parameter includes: at least one of a coding profile, a coding level, quantization parameter information of a geometric component, quantization parameter information of an attribute component, a coding algorithm of a geometric component and a coding algorithm of an attribute component.

In an example, when the first parameter includes the coding profile, the quality indication information is used for indicating that the quality of the media track is related to the coding profile corresponding to the media track, and the higher the coding profile corresponding to the media track, the higher the quality of the media track. The coding profile is used as a part of the metadata to be transmitted to the file unpackaging device, in this way, the file unpackaging device may inquire the coding profile corresponding to the media track in the metadata of the media track according to the quality indication information, and then determine the quality of the media track according to the coding profile corresponding to the media track.

In an example, when the first parameter includes the coding level, the quality indication information is used for indicating that the quality of the media track is related to the level corresponding to the media track, and the higher the level corresponding to the media track, the higher the quality of the media track. The level is used as a part of the metadata to be transmitted to the file unpackaging device, in this way, the file unpackaging device may inquire the level corresponding to the media track in the metadata of the media track according to the quality indication information, and then determine the quality of the media track according to the level corresponding to the media track.

In an example, when the first parameter includes quantization parameter (QP) information of the geometric component, the quality indication information is used for indicating that the quality of the media track is related to the quantization parameter information of the geometric component corresponding to the media track, and the QP information of the geometric component includes a QP value or a QP level of the geometric component. The smaller the QP value or the QP level of the geometric component corresponding to the media track, the higher the quality of the media track. The QP value or the QP level of the geometric component is used as a part of the metadata to be transmitted to the file unpackaging device, in this way, the file unpackaging device may inquire the QP value or the QP level of the geometric component corresponding to the media track in the metadata of the media track according to the quality indication information, and then determine the quality of the media track according to the QP value or the QP level of the geometric component corresponding to the media track.

In an example, when the first parameter includes the QP information of the attribute component, the quality indication information is used for indicating that the quality of the media track is related to the QP information of the attribute component corresponding to the media track, and the QP information of the attribute component includes a QP value or a QP level of the attribute component. The smaller the QP value or the QP level of the attribute component corresponding to the media track, the higher the quality of the media track. The QP value or the QP level of the attribute component is used as a part of the metadata to be transmitted to the file unpackaging device, in this way, the file unpackaging device may inquire the QP value or the QP level of the attribute component corresponding to the media track in the metadata of the media track according to the quality indication information, and then determine the quality of the media track according to the QP value or the QP level of the attribute component corresponding to the media track.

In an example, when the first parameter includes the coding algorithm, the information of the geometric component, the quality indication information is used for indicating that the quality of the media track is related to the coding algorithm of the geometric component corresponding to the media track. The coding algorithm of the geometric component is used as a part of the metadata to be transmitted to the file unpackaging device, in this way, the file unpackaging device may inquire the coding algorithm corresponding to the media track in the metadata of the media track according to the quality indication information, and then determine the quality of the media track according to the coding algorithm of the geometric component corresponding to the media track.

In an example, when the first parameter includes the coding algorithm of the attribute component, the quality indication information is used for indicating that the quality of the media track is related to the coding algorithm of the attribute component corresponding to the media track. The coding algorithm of the attribute component is used as a part of the metadata to be transmitted to the file unpackaging device, in this way, the file unpackaging device may inquire the coding algorithm of the attribute component corresponding to the media track in the metadata of the media track according to the quality indication information, and then determine the quality of the media track according to the coding algorithm of the attribute component corresponding to the media track.

In some embodiments, if a packaging standard of the above media file is ISOBMFF, a data structure of the quality indication information corresponding to the above method 1 is as follows:

| aligned(8) class GPCCQualityInfoStruct { | |
|---|---|
| unsigned int(1) | profile_related_flag; |
| unsigned int(1) level_related_flag; | |
| unsigned int(1) geo_qp_related_flag; | |
| unsigned int(1) attr_qp_related_flag; | |
| unsigned int(1) | geo_algo_related_flag; |
| unsigned int(1) | attr_algo_related_flag; |

}
unsigned int(8) attr_coding_type
}

where, when a value of profile_related_flag is 1, it represents that the quality information of a current track is related to a value of the coding profile, for example, it depends on a value of profile_idc in GPCCDecoderConfigurationRecord.

When a value of level_related_flag is 1, it represents that the quality information of the current track is related to a value of the coding level, for example, it depends on a value of level_idc in GPCCDecoderConfigurationRecord.

When a value of geo_qp_related_flag is 1, it represents that the quality information of the current track is related to a value of the quantization parameter (QP) of the geometric component, for example, it depends on a parameter related to the QP in a geometry parameter set (GPS).

When a value of attr_qp_related_flag is 1, it represents that the quality information of the current track is related to a value of the QP of the attribute component, for example, it depends on a parameter related to the QP in an attribute parameter set (APS).

When a value of geo_algo_related_flag is 1, it represents that the quality information of the current track is related to a coding algorithm of the geometric component, for example, it depends on a parameter related to the coding algorithm in the GPS.

When a value of attr_algo_related_flag is 1, it represents that the quality information of the current track is related to the coding algorithm of the attribute component, for example, it depends on a parameter related to the coding algorithm in the APS.

Method 2: the quality indication information is used for directly indicating a second parameter related to the quality of the media track.

In some embodiments, the second parameter includes: at least one of quantization parameter information of a geometric component, quantization parameter information of an attribute component, whether to use a geometric partition during geometric coding, geometric partition information when using the geometric partition in geometric coding, and an algorithm type of attribute coding.

In some embodiments, the quantization parameter information includes a quantization parameter value or a quantization parameter level.

In an example, when the second parameter includes quantization parameter (QP) information of the geometric component, the quality indication information is used for indicating the quantization parameter information of the geometric component corresponding to the media track, and the QP information of the geometric component includes a QP value or a QP level of the geometric component. The smaller the QP value or the QP level of the geometric component corresponding to the media track, the higher the quality of the media track. In this way, the file unpackaging device may obtain the QP value or the QP level of the geometric component corresponding to the media track according to the quality indication information, and then determine the quality of the media track according to the QP value or the QP level of the geometric component corresponding to the media track.

In an example, when the second parameter includes quantization parameter (QP) information of the attribute component, the quality indication information is used for indicating the quantization parameter information of the attribute component corresponding to the media track, and the QP information of the attribute component includes a QP value or a QP level of the attribute component. The smaller the QP value or the QP level of the attribute component corresponding to the media track, the higher the quality of the media track. In this way, the file unpackaging device may obtain the QP value or the QP level of the attribute component corresponding to the media track according to the quality indication information, and then determine the quality of the media track according to the QP value or the QP level of the attribute component corresponding to the media track.

In an example, when the second parameter includes whether to use a geometric partition during geometric coding, the quality indication information is used for indicating whether the media track uses the geometric partition during geometric coding, if the geometric partition is used, the quality of the media track is low, and if the geometric partition is not used, the quality of the media track is high. In this way, the file unpackaging device may obtain whether the media track uses the geometric partition during geometric coding according to the quality indication information, and then determine the quality of the media track according to whether the media track uses the geometric partition during geometric coding.

In an example, when the second parameter includes the geometric partition information when using the geometric partition in geometric coding, the quality indication information is used for indicating the geometric partition information when the media track uses the geometric partition in geometric coding. The geometric partition information includes at least one of the quantity of partitions or the size of a smallest component. In this way, the file unpackaging device may obtain the geometric partition information when the media track uses the geometric partition in geometric coding according to the quality indication information, and then determine the quality of the media track according to the geometric partition information.

In an example, when the second parameter includes the algorithm type of attribute coding, the quality indication information is used for indicating the algorithm type of attribute coding corresponding to the media track. In this way, the file unpackaging device may obtain the algorithm type of attribute coding corresponding to the media track according to the quality indication information, and then determine the quality of the media track according to the algorithm type of attribute coding.

The above examples all take a situation where a second parameter is indicated in the quality indication information as an example for illustration. In some embodiments, the above second parameters may be combined for use, that is, the quality indication information may indicate a plurality of parameters in the above second parameters.

In some embodiments, a priority may further be set for each above second parameter, the second parameter with a higher priority has a large impact on the quality, and the determination of the priority of each above second parameter is determined according to specific situations, which is not limited in this embodiment.

In some embodiments, if a packaging standard of the above media file is ISOBMFF, a data structure of the quality indication information corresponding to the above method 2 is as follows:

```
aligned(8) class GPCCQualityInfoStruct {
unsigned int(8) geo_qp;
unsigned int(8) attr_qp_level;
unsigned int(8) attr_initial_qp;
unsigned int(8) attr_chroma_qp_offset;
unsigned int(1) gps_implicit_geom_partition_flag;
if(gps_implicit_geom_partition_flag == 1){
  unsigned int(8) gps_max_num_implicit_qtbt_before_ot;
  unsigned int(8) gps_min_size_implicit_qtbt;
}
unsigned int(8) attr_coding_type
}
```

where, geo_qp specifies the QP value of the geometric component, and the smaller the value of this field, the higher the quality of the geometric component. In some embodiments, the value of this field shall be equal to the geom_base_qp_minus4 field in the GPS. In some embodiments, this field may specify the QP level of the geometric component, and the smaller the value of this field, the higher the quality of the geometric component.

attr_qp_level specifies the QP level of the attribute component, and the smaller the value of this field, the higher the quality of the attribute component. In some embodiments, the QP value of the attribute component may further be specifically specified through attr_initial_qp and attr_chroma_qp_offset.

attr_initial_qp specifies an initial QP value of the attribute component, and the smaller the value of this field, the higher the quality of the attribute component. In some embodiments, the value of this field shall be equal to the aps_attr_initial_qp field in the APS. attr_chroma_qp_offset indicates a QP offset value relative to aps_attr_initial_qp. In some embodiments, the value of this field shall be equal to the aps_attr_chroma_qp_offset field in the APS.

Gps_implicit_geom_partition_flag specifies whether to implicitly use the geometric partition in geometric coding. The value of this field shall be equal to the gps_implicit_geom_partition_flag field in the GPS.

gps_max_num_implicit_qtbt_before_ot specifies the maximal number of implicit QT and BT partitions before OT partitions.

gps_min_size_implicit_qtbt specifies the minimal size of implicit QT and BT partitions.

attr_coding_type specifies the algorithm type of attribute coding, and a value is as shown in Table 1 below.

TABLE 1

| attr_coding_type | Coding type |
|---|---|
| 0 | Region adaptive hierarchical transform (RAHT) |
| 1 | LoD with predicting transform |
| 2 | LoD with lifting transform |

The file packaging device adds the quality indication information into at least one media track among the N media tracks according to the above method to obtain the media file of the target point cloud, and then executes the following method of S504.

S504: Send, by a file packaging device, first information to the file unpackaging device, the first information being used for indicating the quality information of the at least one media track among the N media tracks.

A specific form of the first information is not limited to this embodiment, and may be any information that may indicate the quality information of at least one media track among the N media tracks.

In some embodiments, the above first information includes at least one parameter in the above second parameters.

In some embodiments, the first information includes at least one of the quantization parameter information of the geometric component and the quantization parameter information of the attribute component corresponding to at least one media track.

In some embodiments, the above first information is DASH signaling.

In some embodiments, when the above first information is the DASH signaling, the semantic description of the DASH signaling is as shown in Table 2:

TABLE 2

| | | This element contains a description of a |
|---|---|---|
| Description | | Representation. |
| @id | M | specifies an identifier for this Representation. The |
| | | identifier shall be unique within a Period unless the |
| | | Representation is functionally identical to another |
| | | Representation in the same Period. |
| | | The identifier shall not contain whitespace |
| | | characters. |
| | | If used in the template-based URL construction as |
| | | defined in subclause 5.3.9.4.4, the string shall only |
| | | contain characters that are permitted within an |
| | | HTTP-URL according to IETFRFC 3986. |
| @geo_qp | O | specifies the QP value of the geometric component, |
| | | and the smaller the value of this field, the higher the |
| | | quality of the geometric component. The value of |
| | | this field shall be equal to the |
| | | geom_base_qp_minus4 field in the GPS. |
| | | In some embodiments, this field may specify the |
| | | QP level of the geometric component, and the |
| | | smaller the value of this field, the higher the quality |
| | | of the geometric component. |
| @attr_qp_level | O | specifies the QP level of the attribute component, |
| | | and the smaller the value of this field, the higher the |
| | | quality of the attribute component. |

Key
For attributes: M = mandatory, O = optional, OD = optional with default value, and CM = conditionally mandatory
For elements: <minimal occurrence> . . . < maximal occurrence> (n = unbounded)
Element bold; an attribute is non bold and starts with @; and the list of the elements and attributes is represented in italics and bold, referring to the elements and attributes of the basic type extended by this type.

The file packaging device sends the first information to the file unpackaging device, and the first information is used for indicating the quality information of at least one media track among the N media tracks. In this way, the file unpackaging device may determine the media track that needs to be requested or decoded according to the quality information of the at least one media track indicated by the first information, and combined with its own network situation, so that network resources are saved, and the decoding efficiency is improved.

According to the packaging method for the point cloud media file provided by this embodiment of this application, the file packaging device acquires and codes the target point cloud to obtain the alternative group of the target point cloud, the alternative group includes N interchangeable media tracks, the quality indication information is added into at least one media track among the N media tracks to obtain the media file of the target point cloud, and the quality indication information is used for indicating the quality of the media track; and then, the file packaging device sends the first information to the file unpackaging device, and the first information is used for indicating the quality information of the at least one media track among the N media tracks. In this way, the file unpackaging device may determine the media track that needs to be requested or decoded according to the quality information of the at least one media track indicated by the first information, so that network resources are saved, and the decoding efficiency is improved.

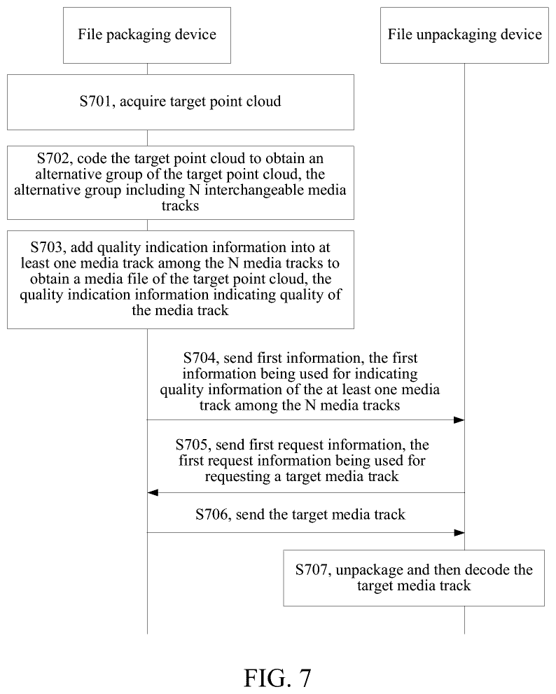

FIG. 7 is an interaction flowchart of a packaging and unpackaging method for a point cloud media file provided by an embodiment of this application. As shown in FIG. 7, this embodiment includes the following steps:

S701: Acquire, by a file packaging device, target point cloud.

S702: Code, by the file packaging device, the target point cloud to obtain an alternative group of the target point cloud, the alternative group including N interchangeable media tracks.

S703: Add, by the file packaging device, quality indication information into at least one media track among the N media tracks to obtain a media file of the target point cloud, the quality indication information being used for indicating quality of the media track.

S704: Send, by the file packaging device, first information to the file unpackaging device, the first information being used for indicating the quality information of the at least one media track among the N media tracks.

The implementation process of S701 to S704 is basically consistent with the implementation process of S501 to S504, referring to the specific description of S501 to S504, which will not be repeated here.

S705: Send, by the file unpackaging device, first request information to the file packaging device according to the first information, the first request information being used for requesting a target media track.

For example, the file unpackaging device requests the consumption of the target media track according to the quality information of at least one media track indicated by the first information and combined with its own device capabilities. Based on this, the file unpackaging device sends the first request information to the file packaging device to request the target media track.

In some embodiments, the first request information includes identification information of the target media track.

S706: Send, by the file packaging device, the target media track to the file unpackaging device according to the first request information.

Specifically, the file packaging device sends the target media track to the file unpackaging device according to the identification information of the target media track carried by the first request information.

S707: Unpackage and then decode the target media track by the file unpackaging device.

Specifically, after receiving the target media track, the file unpackaging device unpackages the target media track first, to obtain an unpackaged code stream, and then decodes the code stream to obtain decoded point cloud.

In some embodiments, if the target media track is an attribute component track of the point cloud, and decoding of an attribute component is based on a geometric component, at this time, before decoding the attribute component track, a geometric component track is decoded.

In order to further describe the technical solutions of the embodiments of this application, description will be made with reference to specific examples below.

Step 11: Assume that the file packaging device acquires a point cloud content A, there are 2 alternative media tracks T1 (geometric and attribute components are packaged in a single track) and T2 in the attribute component of the point cloud content, and the corresponding quality indication information is added into T1 and T2 respectively, specifically as follows:

T1: geo_qp_related_flag=1; attr_qp_related_flag=1; attr_qp_level=0; geo_qp=0;

T2: geo_qp_related_flag=1; attr_qp_related_flag=1; attr_qp_level=3; geo_qp=3;

where, T1 and T2 form an alternative group.

Step 12: Generate DASH signaling (namely the first information) for indicating QP information of representations corresponding to T1 and T2, and the DASH signaling includes the following contents:

Representation1(T1): attr_qp_level=0; geo_qp=0;

Representation2(T2): attr_qp_level=3; geo_qp=3; and

the DASH signaling is sent to a user.

Step 13: Request, by the file unpackaging devices C1 and C2, a point cloud media file according to a network bandwidth and information in the DASH signaling, where the media file requested by the file unpackaging device C1 contains T1, and the media file requested by C2 contains T2.

Step 14: Transmit the point cloud media file.

Step 15: Receive, by the file unpackaging device, the point cloud media file. Specifically, C1 obtains a T1 media track, decodes the T1 media track in the alternative group and presents it. C2 obtains a T2 media track, decodes the T2 media track in the alternative group and presents it.

According to the packaging and unpackaging method for the point cloud media file provided by this embodiment of this application, the file packaging device adds the quality indication information into the at least one media track among the N media tracks in the alternative group to indicate the quality of the media track, and sends the first information to the file unpackaging device, and the first information is used for indicating the quality information of the at least one media track among the N media tracks. In this way, the file unpackaging device may selectively request the target media track for consumption according to the quality information of the at least one media track and the performance of a file decoding device itself, so that the network wide band is saved, and the decoding efficiency is improved.

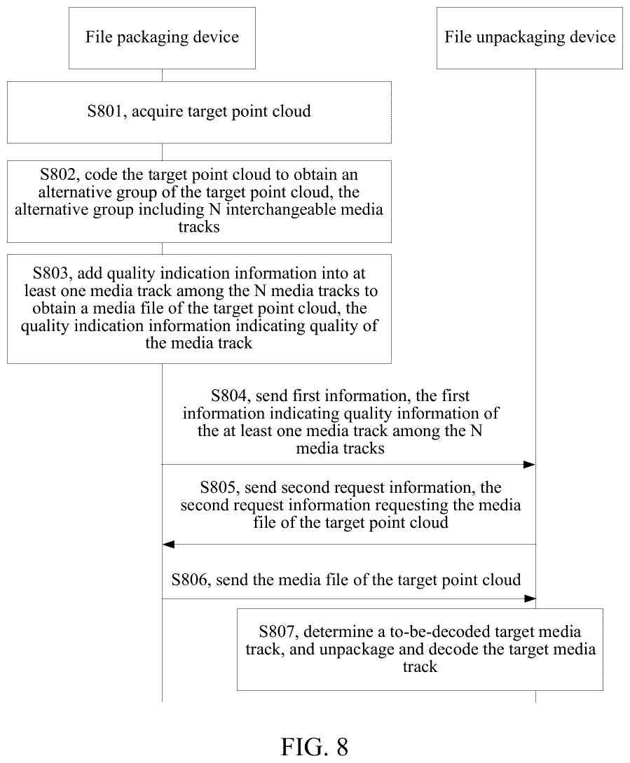

FIG. 8 is an interaction flowchart of a packaging and unpackaging method for a point cloud media file provided by an embodiment of this application. As shown in FIG. 8, this embodiment includes the following steps:

S801: Acquire, by a file packaging device, target point cloud.

S802: Code, by the file packaging device, the target point cloud to obtain an alternative group of the target point cloud, the alternative group including N interchangeable media tracks.

S803: Add, by the file packaging device, quality indication information into at least one media track among the N media tracks to obtain a media file of the target point cloud, the quality indication information being used for indicating quality of the media track.

S804: Send, by the file packaging device, the first information to the file unpackaging device, the first information being used for indicating the quality information of the at least one media track among the N media tracks.

The implementation process of S801 to S804 is basically consistent with the implementation process of S501 to S504, referring to the specific description of S501 to S504, which will not be repeated here.

S805: Send, by the file unpackaging device, second request information to the file packaging device according to the first information, the second request information being used for requesting the media file of the target point cloud.

S806: Send, by the file packaging device, the media file of the target point cloud to the file unpackaging device according to the second request information.

S807: Determine, by the file unpackaging device, a to-be-decoded target media track, and unpackage and then decode the target media track.

Specifically, after requesting the media file of complete target point cloud, the file packaging device determines a to-be-consumed target media track according to the quality information of the at least one media track indicated in the alternative group and combined with its own device capabilities. Then, the target media track is inquired in the media file of the target point cloud and unpackaged to obtain an unpackaged code stream, and then the unpackaged code stream is decoded to obtain decoded point cloud.

In order to further describe the technical solutions of the embodiments of this application, description will be made with reference to specific examples below.

Step 21: Assume that the file packaging device obtains a point cloud content A, there are 2 alternative media tracks T1 and T2 in the attribute component of the point cloud content, and the corresponding quality indication information is added into T1 and T2 respectively, specifically as follows:

T1: attr_qp_related_flag=1; attr_qp_level=0;

T2: attr_qp_related_flag=1; attr_qp_level=2;

where, T1 and T2 form an alternative group.

Step 22: Generate DASH signaling (namely the first information) for indicating QP information of representations corresponding to T1 and T2, and the DASH signaling includes the following contents:

Representation1(T1): attr_qp_level=0;

Representation2(T2): attr_qp_level=2; and

then, the DASH signaling is sent to the file unpackaging device C1 and the file unpackaging device C2.

Step 23: Request, by the file unpackaging device Cl and the file unpackaging device C2, a media file of the target point cloud according to a network bandwidth and information in the DASH signaling, where the media file of the target point cloud contains T1 and T2.

Step 24: Send, by the file packaging device, the media file of the target point cloud to the file unpackaging device C1 and the file unpackaging device C2 respectively.

Step 25: Receive, by the file unpackaging device, a point cloud file.

The file unpackaging device receives the media file of the target point cloud, and C1 selectively decodes a T1 media track in the alternative group and presents it through field information of attr_qp_level in T1 and T2 and its own device capabilities. C2 selectively decodes a T2 media track in the alternative group and presents it.

According to the packaging and unpackaging method for the point cloud media file provided by this embodiment of this application, the file packaging device adds the quality indication information into the at least one media track among the N media tracks in the alternative group to indicate the quality of the media track, and sends the first information to the file unpackaging device, and the first information is used for indicating the quality information of the at least one media track among the N media tracks. In this way, after requesting the media file of the complete target point cloud, the file unpackaging device may selectively decode the target media track according to the quality information of the at least one media track and the performance of a file decoding device itself, so that the network wide band is saved, and the decoding efficiency is improved.

It is to be understood that FIG. 5 to FIG. 8 are only examples of this application, and is not to be understood as limitations to this application.

The embodiments of this application are described in detail above with reference to the accompanying drawings. However, this application is not limited to the specific details in the above implementations, a plurality of simple deformations may be made to the technical solutions of this application within a range of the technical concept of this application, and these simple deformations fall within the protection scope of this application. For example, the specific technical features described in the foregoing specific implementations may be combined in any proper manner in a case without conflict. In order to avoid unnecessary repetition, various possible combination methods will not be described separately in this application. For another example, different implementations of this application may also be arbitrarily combined without departing from the idea of this application, and these combinations shall still be regarded as content disclosed in this application.

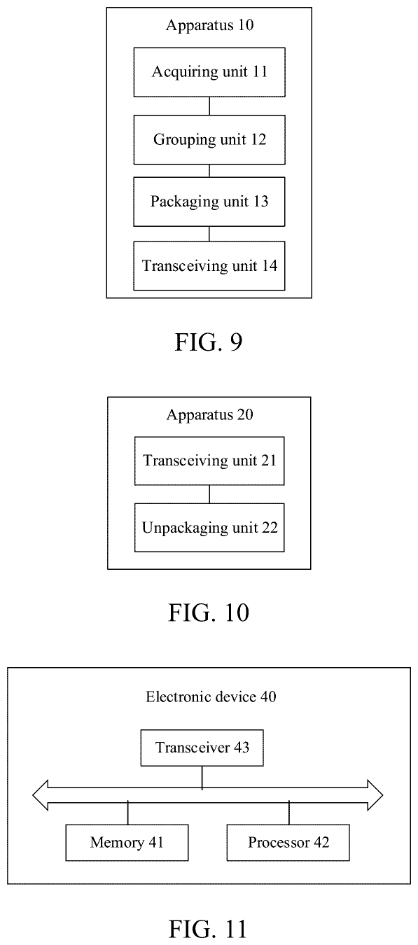

The method embodiments of this application are described above in detail with reference to FIG. 5 to FIG. 8, and apparatus embodiments of this application are described below in detail with reference to FIG. 9 to FIG. 11.

FIG. 9 is a schematic structural diagram of a packaging apparatus for a point cloud media file provided by an embodiment of this application. The apparatus 10 is applied to a file packaging device, and the apparatus 10 includes:

an acquiring unit 11, configured to acquire target point cloud;

a grouping unit 12, configured to code the target point cloud to obtain an alternative group of the target point cloud, the alternative group including N interchangeable media tracks, and N being an integer greater than 1;

a packaging unit 13, configured to add quality indication information into at least one media track among the N media tracks to obtain a media file of the target point cloud, the quality indication information being used for indicating quality of the media track; and

a transceiving unit 14, configured to pack the media file with first information (e.g., send first information to a file unpackaging device), the first information being used for indicating quality information of at least one media track among the N media tracks.

In some embodiments, the quality indication information is used for indicating that the quality of the media track is related to a first parameter corresponding to the media track; and the first parameter includes: at least one of a coding profile, a coding level, quantization parameter information of a geometric component, quantization parameter information of an attribute component, a coding algorithm of a geometric component and a coding algorithm of an attribute component.

In some embodiments, the quality indication information is used for indicating a second parameter related to the quality of the media track; and the second parameter includes: at least one of quantization parameter information of a geometric component, quantization parameter information of an attribute component, whether to use a geometric partition during geometric coding, geometric partition information when using the geometric partition in geometric coding, and an algorithm type of attribute coding.

In some embodiments, the first information includes at least one of the quantization parameter information of the geometric component and the quantization parameter information of the attribute component corresponding to at least one media track.

In some embodiments, the quantization parameter information includes a quantization parameter value or a quantization parameter level.

In some embodiments, the transceiving unit 14 is further configured to receive first request information sent by the file unpackaging device, the first request information being used for requesting a target media track; and send the target media track to the file unpackaging device according to the first request information.

In some embodiments, the transceiving unit 14 is further configured to receive second request information sent by the file unpackaging device, the second request information being used for requesting the media file of the target point cloud; and send the media file of the target point cloud to the file unpackaging device according to the second request information.

It is to be understood that apparatus embodiments may mutually correspond to method embodiments, and similar descriptions may refer to the method embodiments. In order to avoid repetition, it will not be repeated here. Specifically, the apparatus 10 shown in FIG. 9 may execute the method embodiments corresponding to the file packaging device, in addition, the above description and other operations and/or functions of all the modules in the apparatus 10 are used for implementing the method embodiments corresponding to the file packaging device respectively, and for simplicity, it will not be repeated here.

FIG. 10 is a schematic structural diagram of an unpackaging apparatus for a point cloud media file provided by an embodiment of this application. The apparatus 20 is applied to a file unpackaging device, and the apparatus 20 includes:

a transceiving unit 21, configured to receive first information sent by a file packaging device,

the first information being used for indicating quality information of at least one media track among N media tracks of target point cloud, the N media tracks being N interchangeable media tracks in an alternative group of the target point cloud, at least one media track among the N media tracks being added with quality indication information, the quality indication information being used for indicating quality of the media track, and N being an integer greater than 1.

In some embodiments, the quality indication information is used for indicating that the quality of the media track is related to a first parameter corresponding to the media track; and the first parameter includes: at least one of a coding profile, a coding level, quantization parameter information of a geometric component, quantization parameter information of an attribute component, a coding algorithm of a geometric component and a coding algorithm of an attribute component.

In some embodiments, the quality indication information is used for indicating a second parameter related to the quality of the media track; and the second parameter includes: at least one of quantization parameter information of a geometric component, quantization parameter information of an attribute component, whether to use a geometric partition during geometric coding, geometric partition information corresponding to geometric coding, and an algorithm type of attribute coding.

In some embodiments, the first information includes at least one of the quantization parameter information of the geometric component and the quantization parameter information of the attribute component corresponding to at least one media track.

In some embodiments, the quantization parameter information includes a quantization parameter value or a quantization parameter level.

In some embodiments, the apparatus 20 further includes an unpackaging unit 22;

the transceiving unit 21 is further configured to send first request information to the file packaging device according to the first information, the first request information being used for requesting a target media track, and receive the target media track sent by the file packaging device; and

The unpackaging unit 22 is configured to unpackage and then decode the target media track.

In some embodiments, the transceiving unit 21 is further configured to send second request information to the file packaging device according to the first information, the second request information being used for requesting the media file of the target point cloud, and receive the media file of the target point cloud sent by the file packaging device; and
the unpackaging unit 22 is further configured to determine a to-be-decoded target media track, and unpackage and then decode the target media track.

It is to be understood that apparatus embodiments may mutually correspond to method embodiments, and similar descriptions may refer to the method embodiments. In order to avoid repetition, it will not be repeated here. Specifically, the apparatus 20 shown in FIG. 10 may execute the method embodiments corresponding to the file unpackaging device, in addition, the above description and other operations and/or functions of all the modules in the apparatus 20 are used for implementing the method embodiments corresponding to the file unpackaging device respectively, and for simplicity, it will not be repeated here.

The apparatus of this embodiment of this application is described from the perspective of functional modules with reference to the accompanying drawings. It is to be understood that the function module may be implemented in a form of hardware, or through instructions in a form of software, or through combining a hardware module and a software module. Specifically, all the steps of the method embodiments in the embodiments of this application may be completed through an integrated logic circuit of hardware or instructions in a form of software in a processor, the steps of the method disclosed by the embodiment of this application may be directly embodied as being executed and completed by a hardware decoding processor, or may be executed and completed by using a combination of hardware and software modules in the decoding processor. In some embodiments, the software module may be stored in a storage medium that is mature in the art, such as a random access memory, a flash memory, a read-only memory, a programmable read-only memory, an electrically erasable programmable memory, or a register. The storage medium is located in the memory. The processor reads information in the memory and completes the steps in the above method embodiments in combination with hardware thereof.

FIG. 11 is a schematic block diagram of an electronic device provided by an embodiment of this application. The electronic device may be the above file packaging device or the file unpackaging device, or the electronic device has functions of the file packaging device and the file unpackaging device.

As shown in FIG. 11, the electronic device 40 may include:

a memory 41 and a processor 42, the memory 41 being configured to store a computer program and transmit program codes to the processor 42. In other words, the processor 42 may invoke and run the computer program from memory 41 to implement the methods in the embodiments of this application.

For example, the processor 42 may be configured to execute the above method embodiments according to instructions in the computer program.

In some embodiments of this application, the processor 42 may include but is not limited to:

a general-purpose processor, a digital signal processor (DSP), an application specific integrated circuit (ASIC), a field programmable gate array (FPGA), or other programmable logic devices, a discrete gate or transistor logic device, a discrete hardware component, and the like.

In some embodiments of this application, the memory 41 includes but is not limited to:

a volatile memory and/or a non-volatile memory. The non-volatile memory may be a read-only memory (ROM), a programmable ROM (PROM), an erasable PROM (EPROM), an electrical EPROM (EEPROM), or a flash memory. The volatile memory may be a random access memory (RAM) serving as an external cache. Through illustrative but not limited description, RAMs in many forms, for example, a static RAM (SRAM), a Dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM), are available.

In some embodiments of this application, the computer program may be divided into one or more modules, the one or more modules are stored in the memory 41, and executed by the processor 42, to complete the method provided by this application. The one or more modules may be a series of computer program instruction fields that can complete specific functions, and the instruction fields are used for describing an execution process of the computer program in a video production device.

As shown in FIG. 11, the electronic device 40 may further include:

a transceiver 43, which may be connected to the processor 42 or the memory 41.

The processor 42 may control the transceiver 43 to communicate with other devices, specifically, it may send information or data to other devices, or receive information or data sent by other devices. Transceiver 43 may include a transmitter and a receiver. The transceiver 43 may further include antennas, and there may be one or more antennas.

It is to be understood that components of the video production device are connected with each other through a bus system, where in addition to a data bus, the bus system may further include a power bus, a control bus, and a status signal bus.

This application further provides a computer storage medium, storing a computer program. The computer program, when executed by a computer, causes the computer to execute the method in the above method embodiments. Alternatively, an embodiment of this application further provides a computer program product containing instructions, and the instructions, when executed by a computer, enables the computer to execute the method in the above method embodiments.

When implemented by the software, it may be implemented wholly or partially in the form of a computer program product. The computer program product includes one or more computer instructions. When the computer program instructions are loaded and executed on a computer, flows or functions described in the embodiments of this application are wholly or partially generated. The computer may be a general-purpose computer, a special-purpose computer, a computer network, or other programmable apparatuses. The computer instructions may be stored in a computer-readable storage medium or transmitted from one computer readable storage medium to another computer-readable storage medium. For example, the computer instructions may be transmitted from one website, computer, server or data center to another website, computer, server or data center in a wired (for example, a coaxial cable, an optical fiber or a digital subscriber line (DSL)) or wireless (for example, infrared, wireless or microwave) manner. The computer-readable storage medium may be any available medium capable of being accessed by a computer or include one or more data storage devices integrated by an available medium, such as a server and a data center. The available medium may be a magnetic medium (such as a floppy disk, a hard disk, or a magnetic tape), an optical medium (such as a digital video disc (DVD)), a semiconductor medium (such as a solid state disk (SSD)) or the like.

A person of ordinary skill in the art may notice that the exemplary units and algorithm steps described with reference to the embodiments disclosed in this specification can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

In the several embodiments provided in this application, it is to be understood that the disclosed system, apparatus, and method may be implemented in other manners. For example, the foregoing described apparatus embodiments are merely exemplary. For example, the module division is merely logical function division and may be other division in various embodiments. For example, a plurality of modules or components may be combined or integrated into another system, or some features may be ignored or not executed. On the other hand, the mutual coupling or direct coupling or communication connection shown or discussed may be indirect coupling or communication connection through some interfaces, apparatuses or modules, and may be electrical, mechanical or other forms.

The modules described as separate components may or may not be physically separate, and the components displayed as modules may or may not be physical modules, may be located in one position, or may be distributed on a plurality of network units. Some or all of the modules may be selected according to specific needs to realize the objectives of the solutions of the embodiments. In addition, functional modules in the embodiments of this application may be integrated into one processing module, or each of the modules may exist alone physically, or two or more modules are integrated into one module.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the appended claims.

What is claimed is:

1. A packaging method for a point cloud media file, applied to a file packaging device, and comprising:
acquiring target point cloud;
encoding the target point cloud to obtain an alternative group of the target point cloud, the alternative group comprising N interchangeable media tracks, and N being an integer greater than 1;
adding quality indication information into at least one media track among the N media tracks to obtain a media file of the target point cloud, the quality indication information indicating quality of the media track; and
packing the media file with first information, the first information indicating quality information of at least one media track among the N media tracks.

2. The method according to claim 1, wherein the quality indication information indicates that the quality of the media track is related to a first parameter; and
the first parameter comprises at least one of a coding profile, a coding level, quantization parameter information of a geometric component, quantization parameter information of an attribute component, a coding algorithm of a geometric component and a coding algorithm of an attribute component.

3. The method according to claim 1, wherein the quality indication information indicates a second parameter related to the quality of the media track; and
the second parameter comprises at least one of quantization parameter information of a geometric component, quantization parameter information of an attribute component, whether to use a geometric partition during geometric coding, geometric partition information when using the geometric partition in geometric coding, and an algorithm type of attribute coding.

4. The method according to claim 1, wherein the first information comprises at least one of the quantization parameter information of the geometric component and the quantization parameter information of the attribute component corresponding to the at least one media track.

5. The method according to claim 1, further comprising:
receiving first request information transmitted by the file unpackaging device, the first request information requesting a target media track; and
transmitting the target media track to the file unpackaging device according to the first request information.

6. The method according to claim 1, further comprising:
receiving second request information transmitted by the file unpackaging device, the second request information requesting the media file of the target point cloud; and
transmitting the media file of the target point cloud to the file unpackaging device according to the second request information.

7. An unpackaging method for a point cloud media file, applied to a file unpackaging device, and comprising:
receiving first information transmitted by a file packaging device, the first information indicating quality information of at least one media track among N media tracks of target point cloud, the N media tracks being N interchangeable media tracks in an alternative group of the target point cloud, at least one media track among the N media tracks comprising quality indication information, the quality indication information indicating quality of the media track, and N being an integer greater than 1.

8. The method according to claim 7, wherein the quality indication information indicates that the quality of the media track is related to a first parameter; and
the first parameter comprises at least one of a coding profile, a coding level, quantization parameter information of a geometric component, quantization parameter information of an attribute component, a coding algorithm of a geometric component and a coding algorithm of an attribute component.

9. The method according to claim 7, wherein the quality indication information indicates a second parameter related to the quality of the media track; and
the second parameter comprises at least one of quantization parameter information of a geometric component, quantization parameter information of an attribute component, whether to use a geometric partition during geometric coding, geometric partition information corresponding to geometric coding, and an algorithm type of attribute coding.

10. The method according to claim 7, wherein the first information comprises at least one of the quantization parameter information of the geometric component and the quantization parameter information of the attribute component corresponding to the at least one media track.

11. The method according to claim 7, further comprising:
transmitting first request information to the file packaging device according to the first information, the first request information requesting a target media track;
receiving the target media track transmitted by the file packaging device; and
unpackaging and then decoding the target media track.

12. The method according to claim 7, further comprising:
transmitting second request information to the file packaging device according to the first information, the second request information requesting a media file of the target point cloud;
receiving the media file of the target point cloud transmitted by the file packaging device;
determining a to-be-decoded target media track; and
unpackaging and then decoding the target media track.

13. An electronic device, comprising:
a processor and a memory, the memory being configured to store a computer program, and the processor being configured to invoke and run the computer program stored in the memory, to execute a packaging method for a point cloud media file, and the method comprising:
acquiring target point cloud;
encoding the target point cloud to obtain an alternative group of the target point cloud, the alternative group comprising N interchangeable media tracks, and N being an integer greater than 1;
adding quality indication information into at least one media track among the N media tracks to obtain a media file of the target point cloud, the quality indication information indicating quality of the media track; and
packing the media file with first information, the first information indicating quality information of at least one media track among the N media tracks.

14. The electronic device according to claim 13, wherein the quality indication information indicates that the quality of the media track is related to a first parameter; and
the first parameter comprises at least one of a coding profile, a coding level, quantization parameter information of a geometric component, quantization parameter information of an attribute component, a coding algorithm of a geometric component and a coding algorithm of an attribute component.

15. The electronic device according to claim 13, wherein the quality indication information indicates a second parameter related to the quality of the media track; and
the second parameter comprises at least one of quantization parameter information of a geometric component, quantization parameter information of an attribute component, whether to use a geometric partition during geometric coding, geometric partition information when using the geometric partition in geometric coding, and an algorithm type of attribute coding.

16. The electronic device according to claim 13, wherein the first information comprises at least one of the quantization parameter information of the geometric component and the quantization parameter information of the attribute component corresponding to the at least one media track.

17. The electronic device according to claim 13, the method further comprising:
receiving first request information transmitted by the file unpackaging device, the first request information requesting a target media track; and
transmitting the target media track to the file unpackaging device according to the first request information.

18. The electronic device according to claim 13, the method further comprising:
receiving second request information transmitted by the file unpackaging device, the second request information requesting the media file of the target point cloud; and
transmitting the media file of the target point cloud to the file unpackaging device according to the second request information.

19. The electronic device according to claim 14, the method further comprising:
receiving first request information transmitted by the file unpackaging device, the first request information requesting a target media track; and
transmitting the target media track to the file unpackaging device according to the first request information.

20. The electronic device according to claim 14, further comprising:
receiving second request information transmitted by the file unpackaging device, the second request information requesting the media file of the target point cloud; and
transmitting the media file of the target point cloud to the file unpackaging device according to the second request information.
